(19) United States
(12) Patent Application Publication
(10) Pub. No.: US 2010/0248949 A1
(43) Pub. Date: Sep. 30, 2010

(54) Method for photocatalytic activation of structural component surfaces

(75) Inventor: Klaus Droll, Mainz (DE)

Correspondence Address: COLLARD & ROE, P.C., 1077 NORTHERN BOULEVARD, ROSLYN, NY, 11576, US

(73) Assignee: Dyckerhoff AG

(21) Appl. No.: 12/661,448

(22) Filed: Mar. 17, 2010

(30) Foreign Application Priority Data
Mar. 24, 2009 (DE) 10 2009 014 602.4

(51) Int. Cl. B01J 27/053; B01J 23/02; B01J 35/02

(52) U.S. Cl. 502/217; 502/340; 502/100; 977/773

(57) ABSTRACT

A method for photocatalytic activation of at least one surface of a structural component having a porous mineral binder matrix, which is produced from an aqueous mixture of at least one mineral, inorganic binder, and generally at least one aggregate, additive and/or admixture, applies water to the surface of the structural component to be photocatalytically activated, until a film of water forms, immediately afterward applies dry fine-particle binder meal particles and fine-particle photocatalytically active particles in meal form to the water film, reacts the binder meal particles with water of the water film, and allows the water film disappear. The binder meal particles harden to form binder stone having a hydrate crystal matrix so that the photocatalytically active particles are bound into the binder stone, with surfaces remaining free, and the hydrate crystal matrix of the binder stone firmly combines with the surface matrix of the structural component.

### CROSS REFERENCE TO RELATED APPLICATIONS

Applicant claims priority under 35 U.S.C. §119 of German Application No. 10 2009 014 602.4 filed Mar. 24, 2009.

### BACKGROUND OF THE INVENTION

1. Field of the Invention

The invention relates to a method for photocatalytic activation of structural components, particularly mineral structural components, on at least one surface, which structural components have a porous binder matrix, particularly a mineral binder matrix. The structural component surfaces can be uncoated and have a visible concrete surface, for example, or can have a hardened, i.e. cured coating, for example a stucco or mortar having a porous matrix, for example a matrix bound with mineral binders. Porous in the sense of the invention means that pores and capillaries are present in the matrix, for example due to hardening reactions of mineral binders.

Structural components on the basis of a mineral-bound, crystalline matrix, with which the invention is particularly concerned, are structural elements that are intended to be used in such a way that in the installed state, for example in a building, they form at least one surface that receives light. Such structural components are produced from a mixture of at least one mineral, inorganic binder, such as cement, construction lime and/or gypsum or anhydrite, and generally aggregates such as sands, gravels, and crushed stones, for example, and/or additives such as flue ash, stone meals, for example, and/or admixtures such as liquefiers, stabilizers, hydrophobization agents, for example.

These structural components are, for example, finished concrete parts produced in form boards or molds, or concrete components produced on site, in form boards. Equally, these structural components are, for example, concrete goods. In other words, these structural components can be concrete products such as concrete paving stones, concrete pipes, sidewalk and paving panels, curbstones and edging stones, railway platform edgings or the like. Furthermore, these structural components are, for example, concrete ashlars or cement flooring and terrazzo floors or mortar or stucco on structural element surfaces. The production and composition of these structural components are described, for example, in the handbook “Betonfertigteile—Betonwerkstein—Terrazzo” [Finished concrete parts—concrete ashlars—terrazzo], Verlag Bau + Technik GmbH [publisher], Düsseldorf, 1999, particularly in Chapters 5, 6, and 7. The invention, however, also relates to structural components bound with gypsum or anhydrite, particularly finished products bound with gypsum, such as sheetrock panels, gypsum walls, anhydrite floors, and the like.

2. The Prior Art

It is known to coat surfaces of hardened structural components with photocatalytically active nanoparticles such as TiO₂ particles, thereby achieving self-cleaning of the surface. Aside from this self-cleaning effect, surfaces coated with a photocatalyst film can actively contribute to cleaning of the air that surrounds them, in that toxic gases such as NO and NOₓ are photocatalytically oxidized to form NO₂, for example, resulting in non-toxic nitrate ions in an aqueous milieu. Organically bound films, stuccos or mortars have been used as coatings, which are subsequently applied to the structural components after completion of a building structure or after hardening of the components, for example using aqueous. suspensions (for example WO 01/00541 A1, EP 784 034 A1, EP 614 682 A1, DE 10 2005 057 770 A1, U.S. 2 007/0027015 A1, EP 1 020 564 A1, U.S. 2 006/0147756 A1, DE 10 2005 057 747 A1). In this connection, pre-mixes composed of a hydraulic binder and photocatalytically active particles are also used for the production of aqueous mixtures (EP 1 564 194 A2), and the aqueous mixtures are sprayed onto or atomized onto the surfaces (EP 1 020 564 A1).

All these different types of coatings generally have the disadvantage that the other incidental components that are present aside from the photocatalytically active nanoparticles can impair the effectiveness of photocatalysis and/or, in terms of amount, contain too many of the expensive photocatalytical nanoparticles in an inactive state and/or the coating comes loose from the substratum due to weathering influences and/or the coating is destroyed by ambient influences.

Another relatively expensive method is to mix the photocatalytically active nanoparticles into the basic mixture of the structural components. In this connection, although a very large amount of nanoparticles is required, binding of the nanoparticles into the matrix is much stronger than in coatings, and for this reason, their effect is more permanent (for example EP 885 857 A1, IT 1 286 492 A1).

### SUMMARY OF THE INVENTION

It is an object of the invention to equip structural components, particularly molded structural components, of the type described above, with small amounts of photocatalytically active particles, in simple manner and, nevertheless achieve a very effective, permanent photocatalytic effect.

These and other objects are achieved by a method and component according to the invention. Advantageous further embodiments of the invention are discussed below.

According to the invention, first water is applied to the surface of the mineral structural component. The matrix of the structural component draws the water in, essentially in capillary manner, until a temporary certain saturation, i.e. filling of the pores and capillaries, has been reached, for example. Afterwards, a thin film of water forms on the surface of the structural component. This water film is aimed at and produced, according to the invention; it should have a thickness approximately between 0.1 and 5 mm, particularly between 0.1 and 1 mm, and should remain adhering to the surface even in the case of slanted or vertical surfaces. Immediately after application of a water film, for example within a few minutes, before the water film has evaporated or been absorbed by the structural component, a dry mixture composed of at least one mineral, fine-particle, inorganic binder and photocatalytically active particles is applied. For example, the dry mixture may be directly sprayed on, sprinkled on, blown on, or rolled on indirectly, for example with a roller.

It lies within the scope of the invention to apply the types of particles one after the other, as well, and to first cover the aqueous surface with the dry binder particles, for example, and to subsequently cover it with dry photocatalytically active particles, or vice versa.

According to the invention, the amount of water on the surface at the time of application of the dry particles is such that the applied particles are first held in place adhesively. Subsequently, the first chemical reaction phases form from solutions, for example ettringit from cement minerals, or first gypsum phases in the case of stucco gypsum, or anhydrite as a binder of the binder(s) with the water, at least at the surface of the binder particles, which phases bring about preliminary caking, i.e. adhesion of the binder particles to the surface of the structural component, and preliminary binding of the photocatalytically active particles, which do not react chemically with the water and the binder particles, to the binder particles, whereby, however, capillary forces of the structural component matrix also support adhesion of the particles. The first reaction phases of the binders make a transition into crystalline hydrate phases. The crystals of these phases dig into the surface matrix of the structural component and surround the photocatalytically active particles, i.e. embed them, in such a manner that the particles are firmly held in the crystal matrix.

The formation of the reaction hydrate phases of the binders consumes a significant portion of the water reservoir applied in the surface region of the structural component, thereby resulting in solidification of the particles applied and also at least partial water removal from surface regions of the structural component. In order to support and, if necessary, accelerate the formation of the hydrate phases of the binders, it is practical to apply more water to the surface after application of the dry particles, particularly if the surface water evaporates too quickly or has been absorbed by the structural component.

The amount of water that must be applied to the surface of the structural component must be determined empirically. The amount is particularly dependent on the capillary and pore structure of the matrix of the structural component, and on the demand for water of the dry binder particles applied in meal or powder form, and of the dry photocatalytically active particles.

According to the invention, known photocatalytically active particles, for example TiO₂ particles, having particle sizes in the nano range, for example between 1 and 1000 m, and/or in the micro range, for example between 1 and 50 μm, are transferred or applied to a surface, which receives light in the installed state, of a hardened, mineral-bound structural component having a matrix of cement, for example. Hardened means that the structural component is no longer in the fresh state, i.e. in the so-called green or young state, but rather in the solid state (also called solid structural component hereinafter), i.e. the mineral binders have developed their complete crystalline solid structure, as is the case with solid concrete or hardened gypsum structural components, for example.

It is surprising that the photocatalytically active particles can be firmly and permanently disposed on, i.e. bound into the surface of a structural component, without additional adhesion-imparting agents or adhesives, and remain firmly seated on the surface of the structural component even after hardening of the binder. Because the particles do not react chemically with components of the binders, it would have been expected that too many particles would remain lying loosely on the surface and be easily removed, for example by falling off or dropping off in the form of sand. Obviously, the particles are first held in place on the solid structural component surface by means of capillary forces, by capillaries, by way of adhesive water bridges. The capillaries are known to form during hardening of the binders, as the result of excess water in the fresh structural component mixtures that is not used up during the reaction. As a result, the water can migrate from the surface of the structural component into the interior of the structural component, during and after hardening of the binders, and can be used up there during the binder crystal formation (for example calcium silicate hydrate or calcium aluminate hydrate phase formation and/or gypsum dihydrate formation) that forms the solid. Subsequently, the photocatalytically active particles are captured, i.e. embedded in the first hydrate phases of the binder of the application. From there the particles are embedded into the crystal needle or crystal platelet structure of the hardening binder, for example of the hardening cement, the so-called cement stone, and held in place mechanically there, whereby particle surface regions of the photocatalytically active particles that are freely accessible to light and/or gases such as air remain.

Photocatalytically active particles, i.e. particles that can be used are, for example, TiO₂ and/or ZnO and/or other known photocatalytically active particles, particularly mineral-modified photocatalytically active particles having a broader absorption spectrum, for example as described in DE 10 2005 057 770 A1, DE 10 2005 057 747 A1 or WO 01/00541 A1, which can be excited photocatalytically by UV radiation and/or visible light. The photocatalytically active particles are used, for example, in the form of dry powders having particle grain sizes of 5 nm to 50 μm, for example, particularly of 20 to 100 nm, as so-called nanoparticles and/or as microparticles having grain sizes of 0.1 to 50 μm, for example, particularly 0.1 to 1 μm.

The photocatalytically active particles can also be applied, for example, in the form of aqueous powder suspension droplets having droplet diameters of 0.1 to 1000 μm, for example, particularly of 1 to 50 μm, if the binder particles and the photocatalytically active particles are applied to the water film of the dampened structural component surface separately.

The photocatalytically active particles are preferably disposed uniformly distributed over a surface, for example at 0.1 to 100, preferably 0.1 to 50, particularly at 2 to 10 area-%, which means that the surface is covered with corresponding amounts of the particles. The coverage can be distributed homogeneously over the area, or non-homogeneously, for example according to one or more patterns. The coverage can also be distributed over the area completely irregularly, as a computer dot distribution, for example if the binder particles and the photocatalytically active particles are applied separately. In the case of a non-homogeneous area distribution, area coverage of the particle mixture of binder particles and photocatalytically active particles takes place, for example, at 0.1 to 100, preferably 0.1 to 50 area-%, particularly at 2 to 10 area-%. The total amount of the mixture preferably lies below 100 g/m², particularly below 20 g/m², and thus far below the amounts that are required for wet coatings such as stuccos or mortars, and, for example, amount to at least above 30 to 60 g/m², in order to guarantee the desired hold on the surface of the structural component and the same effects.

Application of the photocatalytically active particles and the binder particles takes place directly or indirectly onto the surface of the structural component covered with a water film. Directly, application takes place by way of dusting, sprinkling, spraying or jetting onto the surface of the structural component that contains water.

For indirect transfer, carrier devices, for example films or rollers, are used, on which the particles were previously disposed and are transferred by laying the films down and subsequently pulling them off, or by rolling the particles on with the roller, onto the dampened structural component surface that has a water film.

According to the invention, the photocatalytically active particles are mixed in dry form with a binder powder or binder meal, for example composed of cement, construction lime and/or gypsum or anhydrite, before application. The binder meal particles then react, after application of the dry mixture of binder and active particles onto the wet surface, with the water present on the surface of the structural component, and form first reaction phases. The first reaction phases first bind the photocatalytically active particles into the surface, during stiffening and solidification, and, during subsequent hardening, firmly anchor the particles into the crystal matrix of this binder, with the hardening crystal phases of this binder.

It is practical if mixtures of photocatalytically active particles and binder powder, for example of cement, that can be used have weight amount ratios of 90:10 to 10:90, particularly of 80:20 to 20:80. The binders can be used at grain size ranges between 10 nm and 100 μm. Preferably, cements having grain size ranges between 0.1 μm and 50 μm and/or micro-cements having grain size ranges between 0.1 and 10 μm are used. In particular, a binder is used that has also been used for production of the structural component, and is a cement, for example.

A person skilled in the art can easily recognize, when looking at the structural component treated according to the invention, using an analysis of the surface of the structural component, whether or not the photocatalytically active particles have been applied according to the invention. For example, this analysis can determine whether the particles are firmly bound into an additional, separate crystalline binder matrix that is separated by boundary surfaces from the surface of the structural component, for example into cement stone or into gypsum hydrate stone, and are not lying around on the surface in non-bound form. In particular, however, the invention can also be recognized in that the application, i.e. distribution of the application on the surface is configured in spots, with zones of binder stone material that are situated apart from one another, in which material the photocatalytically active particles are embedded.

In the production of coatings of structural components according to the state of the art, in which the photocatalytically active particles are mixed into an aqueous binder mixture, it is true that there are also particles at the surface of the coating in the fresh or hardened state of the coating; however, these particles are less active, because their surface is generally coated with foreign substances, for example residues of pore solutions, in other words calcium hydroxide or calcium sulfate films, for example. At the same coverage of the structural component surface with active particles, in terms of amount, this coating has been proven to lead to lesser activity of the surface.

Unusually many advantages are accumulated as the result of the invention. Very much smaller amounts of expensive photocatalytically active particles are required for the same photocatalytic effect. The available amount of the particles at the surface can be determined in advance, in simple manner, by simple metering. The coverage of the surface with regard to the amount and/or the type of particles and/or the grain sizes can take place zonally, for example, by using templates, for example. Dry commercially available powders can be used. A mixing problem does not occur in the case of the dry powders, as it does in the case of fresh binder mixtures that contain water. The nanoparticles, in particular, can be mixed only with significant effort into such fresh binder mixtures in order to achieve a homogeneous dispersion, and it is much more difficult to distribute the nanoparticles homogeneously in such mixtures. According to the invention, however, nanoparticles can be applied just as easily as microparticles or mixtures thereof.

In any case, the photocatalytic effectiveness of the active particles can be significantly increased, because they are more freely accessible at the surface of the structural component than in the case of structural components that contain the particles mixed into them, at the same amount on the surface of the structural components.

Another significant advantage of the invention is that the structural component does not experience any losses in strength due to the addition of the photocatalytically active particles. In the case of structural components into which the photocatalytically active particles have been mixed, these particles weaken their strength, because these inert particles do not react with binder components and thus make no contribution to strength.

It lies within the scope of the invention to surface-activate porous structural components with a non-mineral bond and/or non-mineral matrix, according to the invention. In this way, it is possible to form a water film on the surface to be activated, and on the surface of which the hardened mineral binder can adhere.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIGS. 1a to 1e schematically show how the method according to the invention proceeds.

### DETAILED DESCRIPTION OF PREFERRED EMBODIMENTS

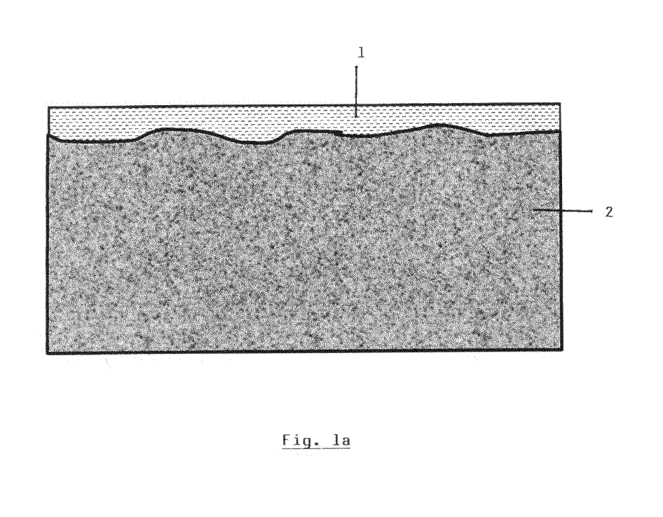

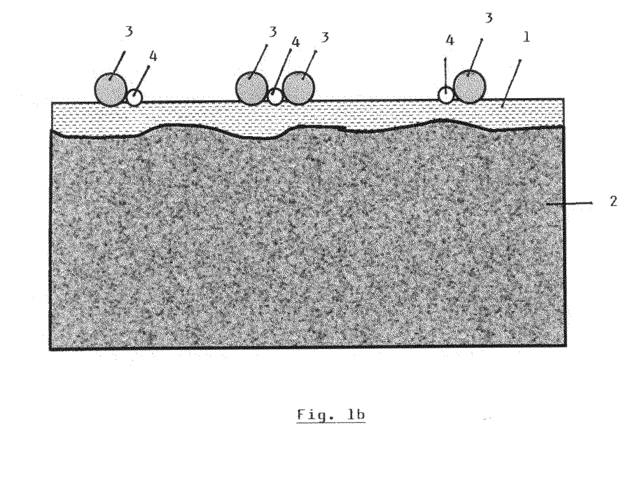

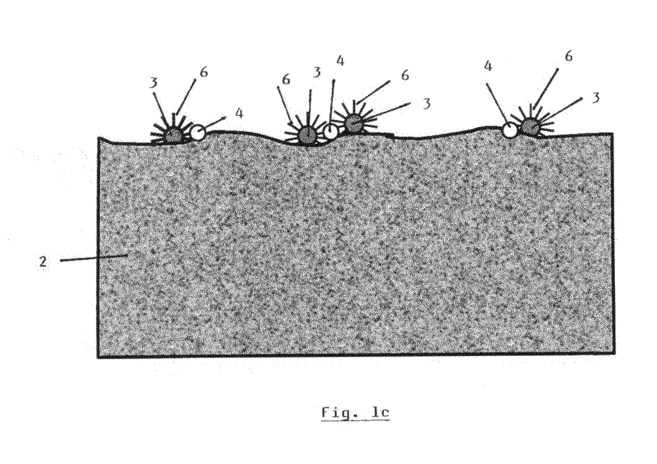

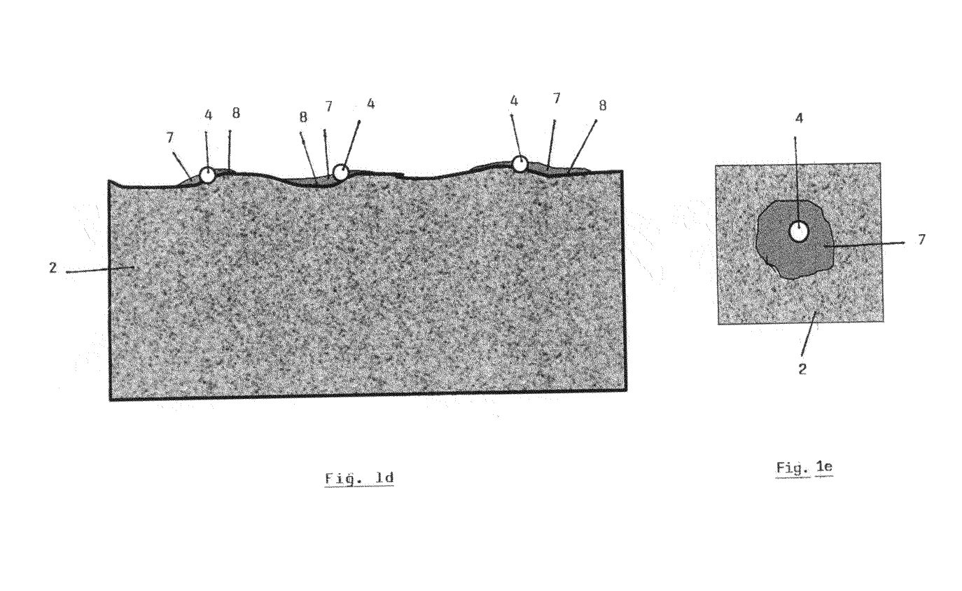

FIG. 1a shows a water film 1 on a structural component 2, for example a concrete structural component. A mixture of binder meal particles 3, for example cement particles, and photocatalytically active meal particles 4, for example TiO₂ particles, are applied onto and at least partly into the water film 1 (FIG. 1b). The binder meal particles 3 begin to react with the water during the first minutes after application, and form first reaction phases 6 that contain water, at least at their grain surface, i.e. particle surface, and glue the photocatalytically active particles 4 onto the binder particles 3 as well as to the structural component surface, whereby water is chemically used up, evaporates and/or penetrates deeper into the matrix of the structural component 2 (FIG. 1c). Afterwards, the first hydrate crystals 6 make a transition into the hardening hydrate phases, whereby the binder minerals and first reaction phases of the binder particles 4 are used up, i.e. chemically converted into the crystalline hardening hydrate phases, which form binder stone material. This hydrate crystal matrix captures the photocatalytically active particles 4, particularly only in part, and the crystals of the hydrate crystal matrix connect with, i.e. anchor into or onto the matrix of the surface region of the structural component 2, i.e. they grow onto the surface matrix of the structural component and/or into the surface matrix of the structural component 2.

In the hardened state of the binder, the application and the adhesion, i.e. fixation of the photocatalytically active particles 4 looks about as spot-like as can be seen schematically in FIG. 1d, in a side view, and in FIG. 1e, in a top view. The photocatalytically active particles 4 are surrounded by hardened binder stone material, for example cement stone material 7, in partial regions, having a thickness between 1 and 1000 μm and a spot diameter between 10 and 5000 μm, for example, which forms a physical boundary layer, i.e. boundary phase 8 relative to the structural component matrix, between the structural component matrix on the surface and the cement stone material 7 composed of the binder of the application, for example, thereby making it possible to recognize that the method according to the invention was carried out. The photocatalytically active particles 4 project out of the cement stone material 7, for example, with free surface regions, which accordingly guarantee activity.

Although only a few embodiments of the present invention have been shown and described, it is to be understood that many changes and modifcations may be made thereunto without departing from the spirit and scope of the invention.

What is claimed is:

1. A method for photocatalytic activation of at least one surface of a structural component having a porous mineral binder matrix produced from an aqueous mixture of at least one mineral inorganic binder and at least one further component selected from the group consisting of an aggregate, an additive, and an admixture comprising the steps of:
(a) applying water to at least one surface of a structural component to be photocatalytically activated until a water film of water forms;
b) immediately afterward applying dry fine-particle binder meal particles and fine-particle photocatalytically active particles in meal form to the water film;
c) allowing the binder meal particles to react with water of the water film;
d) allowing the water film to disappear; and
e) allowing the binder meal particles to harden to form a binder stone having a hydrate crystal matrix so that the photocatalytically active particles are bound into the binder stone with surfaces of the photocatalytically active particles remaining free and the hydrate crystal matrix firmly combining with the surface matrix of the structural component.

2. The method according to claim 1, wherein the porous mineral binder matrix is a capillary-porous mineral structural component selected from the group consisting of a concrete structural component, a mortar coating, a stucco coating, and a gypsum structural component.

3. The method according to claim 1, wherein the mineral inorganic binder is selected from the group consisting of cement, construction lime, gypsum, and anhydrite.

4. The method according to claim 1, wherein the water film is allowed to disappear by evaporation.

5. The method according to claim 1, wherein the water film is allowed to disappear by absorption by the porous mineral binder matrix.

6. The method according to claim 1, wherein the binder meal particles and the fine-particle photocatalytically active particles are applied as a dry mixture.

7. The method according to claim 1, wherein the fine-particle photocatalytically active particles are applied as aqueous powder suspension droplets.

8. The method according to claim 1, wherein the binder meal particles and the fine-particle photocatalytically active particles are applied one after the other.

9. The method according to claim 1, wherein the binder meal particles and the fine-particle photocatalytically active particles are applied as a dry mixture, predominantly in discrete spot regions, onto the at least one surface of the structural component so that the at least one surface is not completely covered.

10. The method according to claim 1, wherein the photocatalytically active particles are applied at particle sizes in at least one range selected from the group consisting of a nano range between 1 and 1000 nm and a micro range between 1 and 50 μm.

11. The method according to claim 1, wherein the photocatalytically active particles are applied at an area-% of 0.1 to 100 area-%.

12. The method according to claim 1, wherein the photocatalytically active particles are homogeneously distributed over an area-% of 0.1 to 50 area-%.

13. The method according to claim 1, wherein the photocatalytically active particles are applied at an area-% of 2 to 10 area-%.

14. The method according to claim 1, wherein the binder meal particles and the photocatalytically active particles are applied indirectly.

15. The method according to claim 1, wherein the binder meal particles and the photocatalytically active particles are applied by way of films.

16. The method according to claim 1, wherein the binder meal particles and the photocatalytically active particles are applied by way of rollers.

17. The method according to claim 1, wherein mixtures of photocatalytically active particles and binder meal particles are applied at weight amount ratios of 90:10 to 10:90.

18. The method according to claim 1, wherein mixtures of photocatalytically active particles and binder meal particles are applied at weight amount ratios of 80:20 to 20:80.

19. The method according to claim 1, wherein the at least one mineral binder has a grain size range between 10 nm and 100 μm.

20. The method according to claim 19, wherein the grain size range is between 0.1 μm and 50 μm.

21. The method according to claim 19, wherein the at least one mineral binder comprises a micro-cement having a grain size range between 0.1 and 10 μm.

22. A component comprising a porous mineral binder matrix produced from an aqueous mixture of at least one mineral inorganic binder and at least one further component selected from the group consisting of an aggregate, an additive, and an admixture, said binder matrix having at least one surface comprising a plurality of spot regions composed of a binder stone and a plurality of photocatalytically active particles disposed in firmly held manner in the spot regions.

23. The component according to claim 22, wherein the photocatalytically active particles have particle sizes in at least one range selected from the group consisting of a nano range between 1 and 1000 nm and a micro range between 1 and 50 μm.

24. The component according to claim 22, wherein the photocatalytically active particles are present at an area-% of 0.1 to 100 area-%.

25. The component according to claim 22, wherein the photocatalytically active particles are present at an area-% of 0.1 to 50 area-%.

26. The component according to claim 22, wherein the photocatalytically active particles are present at an area-% of 2 to 10 area-%.
